(19) United States
(12) Patent Application Publication
(10) Pub. No.: US 2026/0356012 A1
(43) Pub. Date: Nov. 12, 2026

(54) VELVET-TRANSFER ANTLER MOLD

(71) Applicant: Trenton A. Titus, Enterprise, OR (US)

(72) Inventor: Trenton A. Titus, Enterprise, OR (US)

(21) Appl. No.: 19/200,937

(22) Filed: May 7, 2025

(51) Int. Cl. B29C 33/38; B29L 31/00

(52) U.S. Cl. CPC B29C 33/3842; B29K 2883/00; B29K 2891/00; B29L 2031/7028

(57) ABSTRACT

A velvet-transfer antler mold as well as a method for the formation of a velvet-transfer replica deer antler are provided. The method for the formation of a velvet-transfer replica deer antler includes providing a natural velvet antler that includes a hard antler, a soft tissue layer, and hairs. The method further includes the usage of a material mold by applying silicone onto the entire external surface of the natural velvet antler. Afterward, the soft tissue layer of the natural velvet antler is allowed to naturally decompose. The method further involves pouring a casting material into a mold void formed inside the material mold after the removal of the hard antler and soft tissue from the material mold. The newly formed replica deer antler includes hair embedded in the casting material. The replica deer antler has natural hairs on the outside surface, thus providing a feeling of an “original” product.

### TECHNICAL FIELD

The present invention generally relates to the field of molding/casting. More particularly, the present invention relates to a velvet-transfer antler mold that allows transferring the hair from the natural velvet antler to the casting material.

### BACKGROUND

Antlers are deciduous, solid, bony processes that arise from the frontal bone on the head of an animal of the deer family (Cervidae). While the bony antlers grow, they are covered in soft tissue and hair known collectively as “velvet” and the antlers are considered to be “velvet antlers”. Once the antlers have finished growing, the velvet strips off, and only the solid bony structure of the antler is left, known from here forward as the “hard antlers”. After the breeding season, deer will cast, or shed, their antlers and will repeat the process to grow a new set the following year.

Antlers are often preserved and displayed for decorative/aesthetic purposes generally associated with the taxidermy industry. Hard antlers that have lost their velvet require little to no preservation as they are solid bone material. However, to preserve velvet antlers, the soft tissue of the velvet has to be cured in some way to prevent decomposition. Generally, velvet antlers are dried and often treated with some form of preservative such as embalming fluids or alcohol to prevent decomposition.

In addition to preserving antlers for decorative/aesthetic purposes, nowadays, a single set of antlers can be replicated in order to create multiple copies of that specific set to be used for the aforementioned purposes. Replica antlers are typically made by making a mold of the original natural antlers and then using the mold to create an artificial antler from casting materials including, but not limited to, urethane resins. This molding process is somewhat limited to hard antlers that have already lost the velvet tissue covering. Generally, antlers that are still in the velvet stage, being covered in soft tissue and hair, cannot be replicated without destructively removing the velvet tissue/hair and making a mold of the hard antlers underneath. Both the original hard antlers as well as replica hard antlers can then be sculpted over to replace the lost soft tissue and then coated with synthetic fibers (flocking) to mimic the appearance of natural velvet hair. Alternatively, the sculpting and application of synthetic fiber can be foregone and the antlers can be left to resemble hard antlers. This gives the option to create replicas resembling the hard antlers as well as to re-create artificial velvet antlers that mimic the appearance of the original velvet antlers. However, the natural velvet is destroyed in the process and only antlers sculpted over and coated with synthetic fibers can be created to try and mimic the original appearance of natural velvet antlers.

The typical options for preserving natural velvet antlers have multiple drawbacks. If the natural velvet is to be retained, it is dried in place on the underlying hard antler. This drying of the velvet tissue is typically associated with some level of shrinkage and distortion of the velvet tissue. Thus, preserved natural velvet fails to completely preserve the original appearance of the velvet antlers. Additionally, preserving the natural velvet on the antlers is mutually exclusive with accessing the hard antlers inside. The natural velvet can be preserved OR the natural velvet can be destroyed to access the underlying hard antlers. Finally, because velvet-antler preservation results in a product that includes dehydrated organic tissues, the preserved velvet antlers are susceptible to infestation by insects and damage from external moisture.

Various solutions exist in prior art that address the aforementioned problems. Typically, to address the shrinkage problems, the soft tissue is injected under the natural velvet with certain materials that permeate and harden in shape and/or work to embalm the soft tissue. These injections are often followed by freeze-drying to remove the moisture from the tissue without losing as much shape as compared with natural drying.

Further, insect damage is typically addressed in prior art with injection/application of embalming fluids such as formaldehyde and/or insect-repelling essential oils. However, problems such as susceptibility to moisture damage are not addressed in the prior art.

Solutions for accessing hard antlers without destroying the natural velvet are not typically addressed, but potential solutions do exist in the market that discloses skinning the natural velvet off, preserving/drying it like leather, and then sewing it back over replicas of the hard antlers. This solution could give access to the natural hard antlers without destroying the natural velvet. However, this solution would only partially address shrinkage and durability issues related to natural velvet antlers.

The above-mentioned limitations of preserving the tissues and appearance of velvet antlers and limitations of replicating velvet antlers would restrict the commercial deployment of replica antlers as well as restrict the available quality of preservation for velvet antlers in the market. In an attempt to scale up the use of replica deer antlers, specifically concerning velvet antlers, and to improve the available quality of velvet-antler preservation, there remains a need to suggest a replica antler as well as a method for forming the replica antler that is capable of solving the aforementioned problems of the replicating and preserving of velvet antlers.

### SUMMARY

Before the present systems, methods, and embodiments are described, it is to be understood that this application is not limited to the particular systems and methodologies described, as there can be multiple possible embodiments that are not expressly illustrated in the present disclosures. It is also to be understood that the terminology used in the description is for the purpose of describing the particular versions or embodiments only, and is not intended to limit the scope of the present application. Further, it is also to be understood that the terminology, if not defined by the present disclosure, should be construed as the general or known meaning/definition of the terminology, known to the person skilled in the art.

It is an object of the present invention to provide a method for formation of a velvet-transfer replica deer antler comprising the steps of providing a natural velvet antler, wherein the natural velvet antler comprises a hard antler covered from any or all external sides by a soft tissue layer and hairs extending from the outside surface of the soft tissue layer, creating a mold over the entire external surface of the natural velvet antler, allowing the soft tissue layer of the natural velvet antler to naturally decompose, wherein the natural decomposition of the soft tissue layer enables releasing the hairs from the soft tissue layer and allows hairs to be encased in the material mold, removing the hard antler and soft tissue from the material mold by cutting the material mold, wherein the material mold comprises encased hair, pouring a casting material into the mold void wherein the mold void is formed inside the material mold after removal of the hard antler and soft tissue from the material mold, allowing the casting material to be cured inside the mold void, thereby forming a replica deer antler and removing the material mold from the replica deer antler, wherein the newly formed replica deer antler includes the natural hair embedded in the exterior surface of the replica deer antler.

It is an object of the present invention to provide a method for the formation of a velvet-transfer replica deer antler that enables the high-quality preservation of natural velvet by transferring the natural hair from a natural velvet antler over to a synthetic replica of the original velvet antler. In addition, the velvet-transfer antler mold can be used to create additional replicas that have the shape of the hard antlers and soft tissue. These replicas can have synthetic fiber (flocking) applied to mimic additional velvet antlers without the need to sculpt the shape of soft tissue over a hard antler.

It is another object of the present invention to provide a method for the formation of a velvet-transfer replica deer antler that enables a user to form a velvet-transfer replica deer antler that includes the natural hair embedded in the exterior surface of the replica deer antler, as well as provide access to the natural hard antlers for further uses.

Embodiments of the present invention disclose a method for the formation of a velvet-transfer replica deer antler comprising the steps of: providing a natural velvet antler wherein the natural velvet antler comprises a hard antler covered from any or all external sides by a soft tissue layer and hairs extending from the outside surface of the soft tissue layer, creating a material mold by applying a mold material onto the entire external surface of the natural velvet antler, enabling the release of the hairs from the soft tissue layer and allowing hairs to be encased in the material mold; removing the hard antler and soft tissue from the material mold by cutting the material mold wherein the material mold comprises encased hair.

In another embodiment, the material mold is supported by using a rigid mother mold that includes a pair of flanges that are removably connected to each other.

In another embodiment, the hairs are released from the soft tissue layer using natural bacterial decomposition.

In another embodiment, the hairs are released from the soft tissue layer using a process selected from a group comprising chemical application, heating, and/or combinations thereof.

In another embodiment, the casting material comprises at least one of: plastic, acrylic (PMMA), acrylonitrile butadiene styrene (ABS), nylon (polyamide, PA), polycarbonate (PC), polyethylene (PE), polyoxymethylene (POM), and combinations thereof.

In another embodiment, the natural velvet antler is selected from an animal comprising: mule deer, elk, reindeer, moose, red deer, Fallow deer caribou, Chital and sambar deer, or any other member of the deer family (Cervidae).

In another embodiment, the mold material comprises at least one of: silicone, wax, and combinations thereof.

In another embodiment, the method for the formation of a velvet-transfer replica deer antler comprises the additional steps of initially rehydrating the natural velvet antler with water.

### BRIEF DESCRIPTION OF DRAWINGS

FIG. 1 illustrates a front perspective view of a typical deer skull comprising typical natural velvet antlers;

FIG. 2 illustrates a cross-sectional view of a typical natural velvet antler of FIG. 1; and

FIGS. 3-12 illustrate various steps for forming a velvet-transfer replica deer antler, according to an embodiment of the present invention.

### DETAILED DESCRIPTION

Before describing the present invention in detail, it should be observed that the present invention utilizes a combination of components or processes, which constitutes a velvet-transfer replica deer antler. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component-level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

Some embodiments, illustrating its features, will now be discussed in detail. The words “comprising,” “having,” “containing,” and “including,” and other forms thereof, are intended to be equivalent in meaning and be open-ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

References to “one embodiment”, “an embodiment”, “another embodiment”, “one example”, “an example”, “another example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open-ended in that an item or items following any one of these words is not meant to be an exhaustive listing of such item or items or meant to be limited to only the listed item or items.

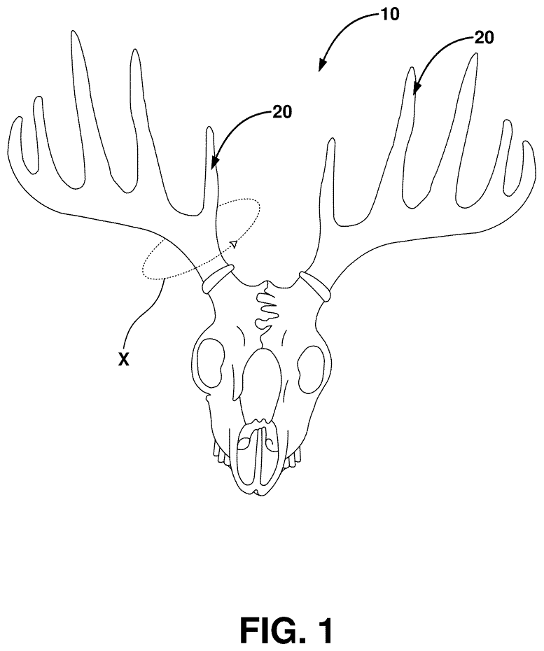

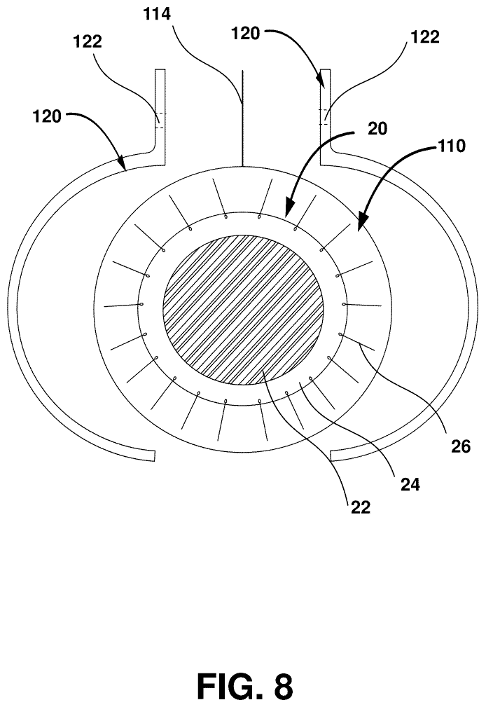

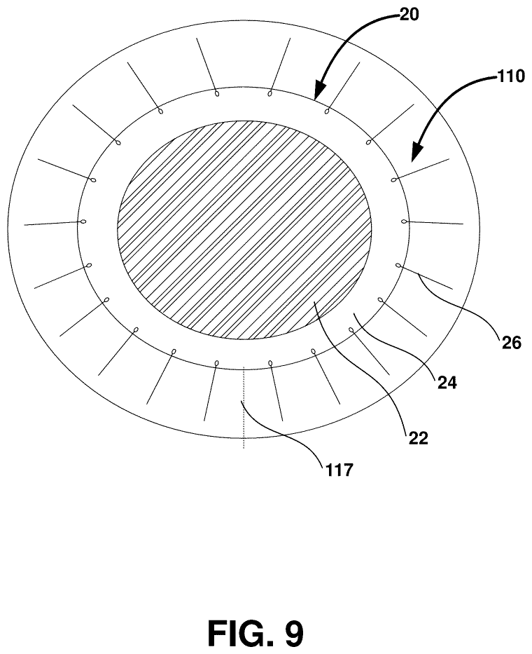

The velvet-transfer replica deer antler as well as a method for forming the aforementioned velvet-transfer replica deer antler will now be described with reference to the accompanying drawings, particularly FIGS. 1-12.

FIG. 1 illustrates a front perspective view of a typical deer skull 10 comprising a typical set of natural velvet antlers 20. The deer skull 10 could belong to any member of the Cervidae (deer) family, such as but not limited to mule deer, elk, reindeer, moose, caribou, sambar deer, red deer, Fallow deer, Chital, and so on.

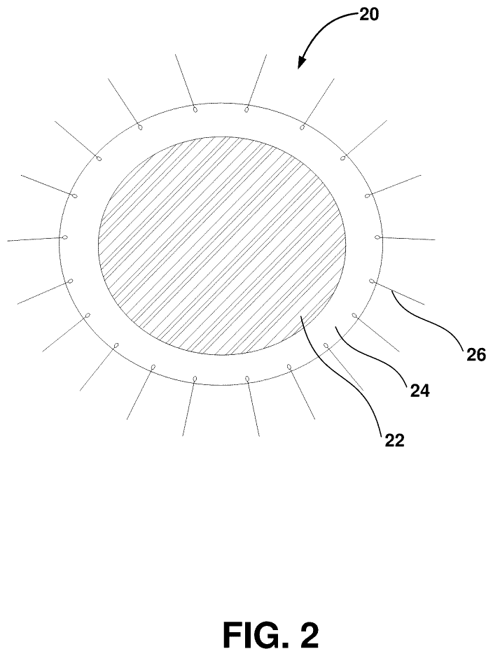

FIG. 2 illustrates a cross-sectional view of a typical natural velvet antler 20 shown along cross-section X of FIG. 1. Generally speaking, the natural velvet antler 20 has a multi-layer structure wherein a hard antler 22 is covered from all external sides by a soft tissue layer 24. Further, hairs 26 extend from the outside surface of the soft tissue layer 24.

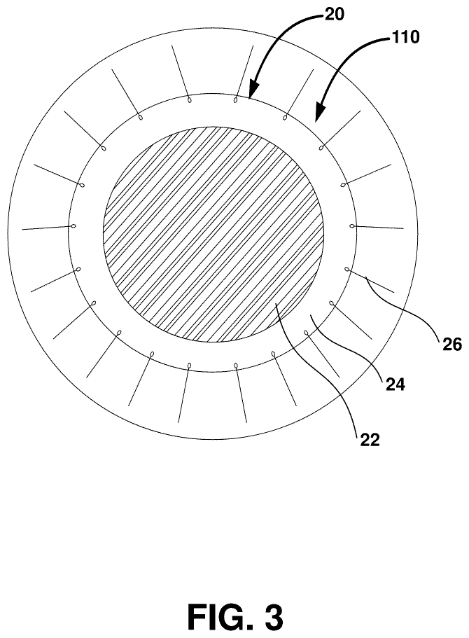

FIGS. 3-12 illustrate various steps for forming (creating) a replica (artificial) deer antler 100, according to an exemplary embodiment of the present invention.

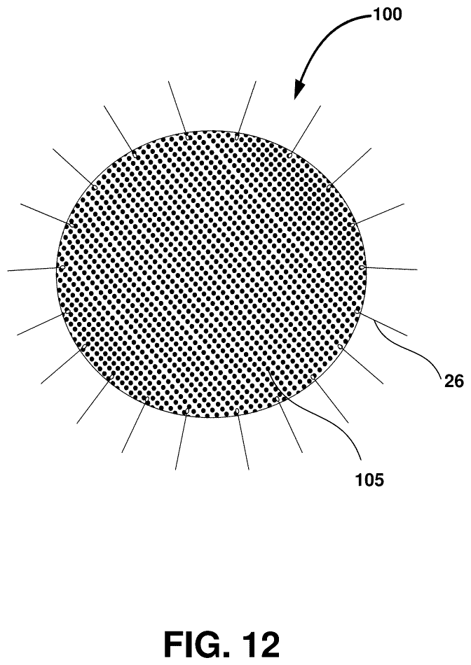

To begin the formation of the Velvet-transfer replica deer antler 100 (FIG. 12), the natural velvet antler 20 is soaked with water, or water is injected into the soft tissue layer 24. This process could be skipped (omitted) if fresh/thawed natural velvet antler 20 is used that already has sufficient moisture. In other words, rehydration is not always necessary for initiating the formation of the velvet-Transfer Replica deer antler 100 (FIG. 12).

Once the natural velvet antler 20 is sufficiently hydrated, a material mold 110 is made (created) by applying a two-part mold-making silicone as seen in FIG. 3. The silicone (mold material) is mixed and then applied (brushed) onto the entire external surface of the natural velvet antler 20, wherein the entire external surface of the natural velvet antler includes soft tissue layer 24, encasing the hairs 26 and soaking down to the surface of the soft tissue layer 24. Additional layers of silicone are added to get the desired thickness for a durable material mold 110. The material mold 110 is configured to hold the hairs 26, while the soft tissue layer 24 and hard antler 22 will be removed from the material mold 110 in the following steps, as described in greater detail below.

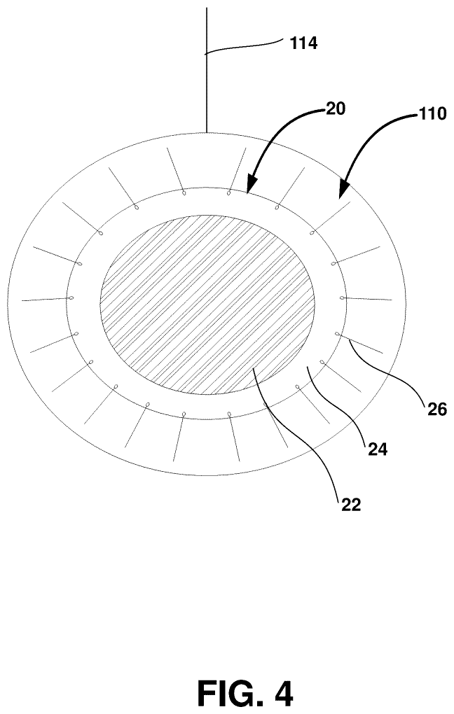

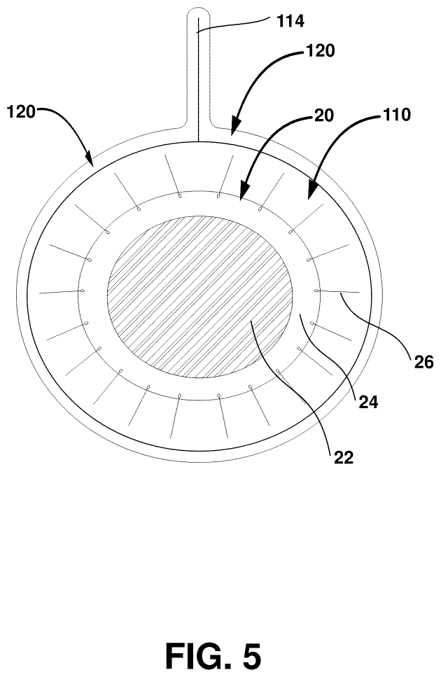

After the material mold 110 has cured (set in place), flanges 114 (FIG. 4) are attached along mapped-out (imaginary) lines as seen in FIG. 4 that divide the surface into sections from where that section of a rigid mother mold 120 (FIG. 5) could be removed by avoiding undercuts and bends that would mechanically lock a rigid mother mold 120 (FIG. 5) section from being taken off of the material mold 110.

In another embodiment (not shown in figures), the flanges 114 could be omitted (not shown in figures) wherein the mother mold 120 (FIG. 5) could be reassembled by other means, such as adhesive tape (not shown in figures).

Afterwards, as seen in FIG. 5, a rigid mother mold 120 is then created over the top of the material mold 110 and the flanges 114 using a two-part resin and fiberglass reinforcement. Multiple layers are generally necessary to create a durable and rigid mother mold 120.

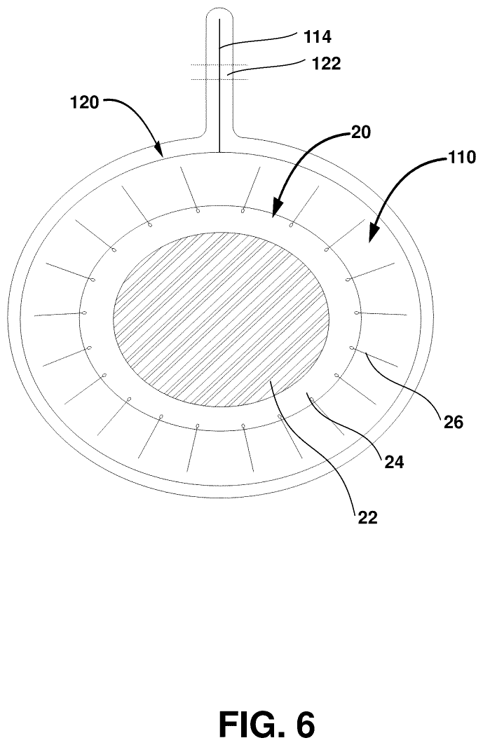

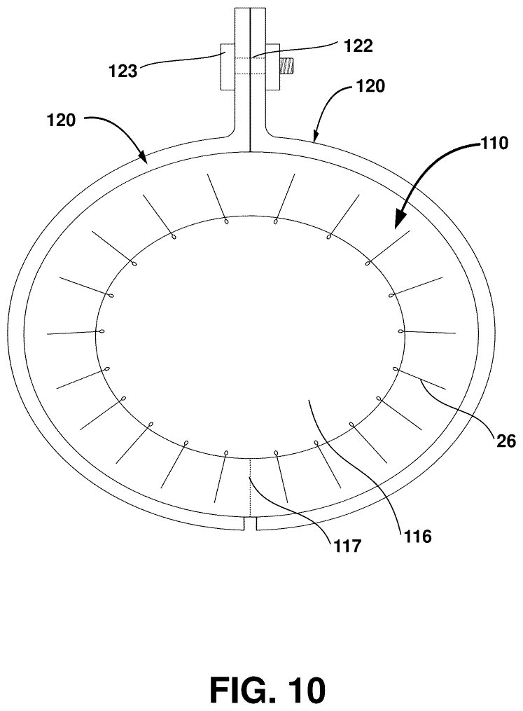

As seen in FIG. 6, once the mother mold 120 has cured, holes 122 are drilled through the flanges 114 for bolting the mother mold 120 back together using bolts 123 after it has been removed in sections, as will be described in reference to FIG. 10.

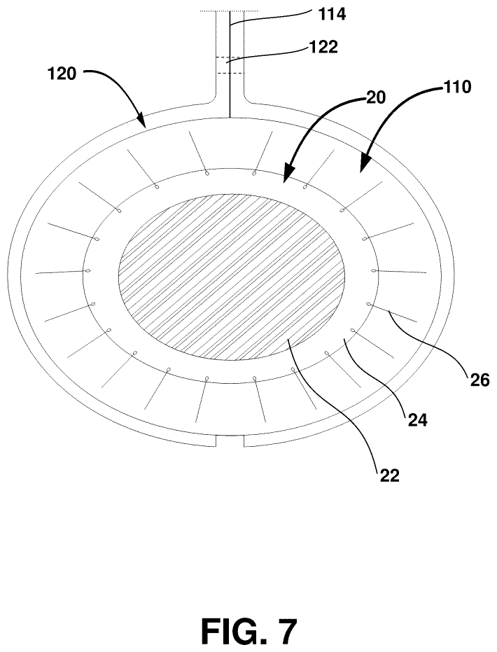

Afterwards, as seen in FIGS. 7-9, the mother mold 120 is removed by cutting/grinding through the mother mold 120 material along the mapped-out lines and the edges of the flanges 114 that further separate (section) the mother mold 120 into removable, rigid sections.

Now the natural velvet antler 20 is left encased in the material mold 110, while the soft tissue layer 24 naturally decomposes via bacterial growth. Thus, releasing the hairs 26 from the soft tissue layer 24 is accomplished using natural bacterial decomposition.

In another embodiment (not shown in figures), releasing the hairs 26 from the soft tissue layer 24 could be accomplished by using means such as but not limited to: chemical application or cooking (heating) the natural velvet antler 20 in the material mold 110 to get the soft tissue layer 24 to release the hairs 26. It should be understood that any means of releasing the hairs 26 from the soft tissue layer 24 will serve the same purpose and will result in the same end product with little to no variation.

Once sufficient decomposition has taken place for the soft tissue layer 24 to release the follicles of hair 26, the material mold 110 can be removed with the hair 26 still encased (held) in the mold material (silicone). The material mold 110 that is holding hairs 26 now is removed from the natural velvet antler 20 by simply cutting through the material mold 110 using cuts 117 made in a radial direction from the natural velvet antler 20 as is necessary to free the material mold 110 from the hard antler 22 inside.

Afterward, the material mold 110, with encased hair 26, is thoroughly washed (optional) to remove any remnants (residue) of the soft-tissue layer 24 and oils from the inside of the material mold 110 and the exposed follicles of hair 26. The material mold 110 is thoroughly dried after washing.

Afterwards, as seen in FIG. 10, the rigid mother mold 120 is reassembled around the material mold 110 using bolts 123 through the corresponding holes 122 that were earlier drilled through the flanges 114 of adjacent sections of the mother mold 120.

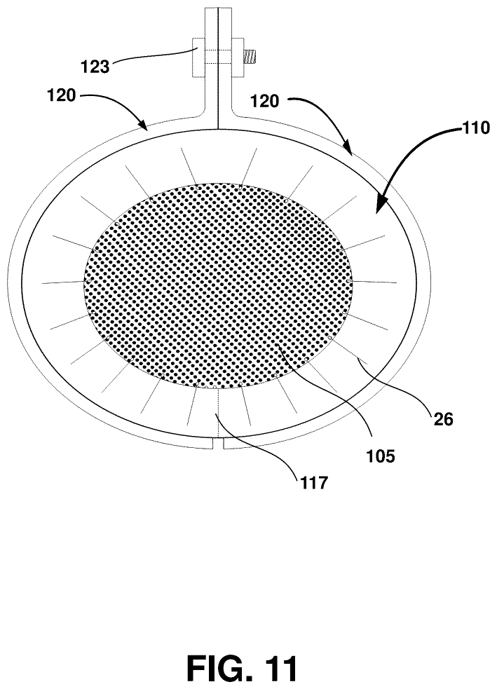

Afterwards, as seen in FIG. 11, a casting material 105, in the form of a two-part resin, preferably plastic, is poured into the mold void 116. The mold void 116 is formed inside the material mold 110 after the removal of the hard antler 22 and soft tissue 24. The casting material 105 is poured into the mold void 116 as a liquid that hardens into a rigid material (plastic) after it is cured.

In another embodiment (not shown in figures), the casting material 105 could be any material that can fill the space of the mold void 116 and then bond to the exposed hair follicles 26 more firmly than the remainder of the hair 26 is bonded to the material mold 110. The casting material 105 could include, but is not limited to, plastic, acrylic (PMMA); acrylonitrile butadiene styrene (ABS); nylon (polyamide, PA); polycarbonate (PC); polyethylene (PE); polyoxymethylene (POM).

Referring to FIG. 11, once the casting material 105 (plastic) is cured; the mother mold 120 is simply disassembled by removing bolts 123 from the holes 122. The material mold 110 is removed from the newly-created replica deer antler 100 by peeling it away using the cuts 117 made while removing the material mold 110 from the natural velvet antler 20. The hairs 26 are now firmly bonded to the casting material 105 and pull free from the silicone material mold 110 that has been encasing it earlier. As seen in FIG. 12, the newly-created velvet-transfer replica deer antler 100 includes hair 26 embedded in the casting material 105 that has cured within the mold void 116.

In another embodiment (not shown in figures), the entire soft tissue layer 24 is not removed during the process of releasing the hairs 26 from the soft tissue layer 24, and some residual soft tissue layer 24 is left attached to the hairs 26 in the material mold 110. Then the two-part resin casting material 105, as seen in FIG. 11 is poured into the mold void 116 formed inside the material mold 110 and would bond to the inside of that residual soft tissue layer 24 that still holds the hair follicles 26. In other words, the mold void 116 is filled with a casting material 105 that is configured to bond directly or indirectly to the hair 26 and/or the residual soft tissue layer 24. This would produce a similar velvet-transfer replica deer antler 100. However, the residual soft tissue layer 24 would be susceptible to shrinking and spoiling, and would not be highly durable.

In another embodiment (not shown in figures), the silicone used as mold material in the material mold 110 could be substituted (replaced) with another mold material such as but not limited to: wax and so on that can be applied as a liquid, cured to a solid, and then removed by peeling or melting.

In another embodiment (not shown in figures), the method of formation (creation) of the velvet-transfer replica deer antler 100 does not require the usage of the rigid mother mold 120. This embodiment is particularly useful when the material mold 110 is made of sufficiently strong (rigid) material that can hold its shape.

In another embodiment (not shown in figures), the method of formation (creation) of the velvet-transfer replica deer antler 100 does not include (require) drilling the holes 122 for bolt fastening in reassembly or the flanges 114 for the process to be functional and to create the same velvet-transfer replica deer antler 100.

Certain advantages of the velvet-transfer replica deer antler 100 of the present disclosure are listed herein below:

Velvet-Transfer Replica deer antlers 100 allow for access to the natural hard antlers 22 while maintaining the ability to preserve the original appearance of the velvet antlers by displaying the natural velvet hair 26 as it was on the natural velvet antlers 20. Because the hair 26 of the natural velvet is transferred off of the natural velvet antler 20 and over to a velvet-transfer replica deer antler 100, the hard antlers 22 can be accessed without destroying the natural velvet hair 26 when it is removed.

The velvet hair 26 of natural velvet antlers 20 can be preserved in appearance without any of the shrinkage and distortion that is associated with drying the natural velvet tissue 24 to preserve it. Because the hair 26 is transferred directly over to a replica that captures the shape of a hydrated velvet antler 20, the resulting velvet-transfer replica 100 gives a much more authentic appearance of live velvet antlers 20 as compared to natural velvet antlers 20 that have been preserved by the dehydration of the velvet tissue 24. All existing methods of preserving natural velvet antlers 20 include drying/preserving the soft tissue layer 24 which poses aesthetic problems related to shrinkage.

Because only the hair 26 itself is transferred to the velvet-transfer replica deer antler 100, the end product is more durable than natural velvet antlers 20 that are preserved by drying the soft tissue layer 24 in place. All existing methods produce dried tissue that is susceptible to damage from insects and moisture. Velvet-transfer replication removes the soft tissue layer 24 as well as the hard antler 22 and replaces them with a casting material 105.

The method for the formation of a velvet-transfer replica deer antler 100 removes the problematic necessity of preserving natural velvet tissue 24 by displaying the natural velvet hair 26 on a synthetic velvet-transfer replica 100 and removing the organic velvet tissue 24 and hard antlers 22 altogether.

The method for the formation of a velvet-transfer replica deer antler 100 serves multiple purposes. The method for the formation of a velvet-transfer replica deer antler 100 enables a user to form a velvet-transfer replica deer antler 100 that includes the natural hair 26 embedded in the exterior surface of a casting material 105, as well as to access the hard antlers for further uses. Broadly speaking, a user can retain the natural velvet hairs 26 on velvet-transfer replica antlers 100 that resemble the original natural velvet antlers 20 and also have access to the natural hard antlers 22 for further use. Further, it should be understood that the method for the formation of a velvet-transfer replica deer antler 100 could have applications in small-scale personal usage as well as large-scale commercial usage.

The various components and parts of the various embodiments of the velvet-transfer replica deer antler 100 of the present invention are similar and interchangeable. It is obvious to the one skilled in the art that the various components and parts of the velvet-transfer replica deer antler 100 of one embodiment of the present invention could be considered for other embodiments with little or no variation.

It should be understood according to the preceding description of the present invention that the same is susceptible to changes, modifications, and adaptations and that the said changes, modifications, and adaptations fall within the scope of the appended claims.

What is claimed is:

1. A method for the formation of a velvet-transfer replica deer antler (100) comprising the steps of:
providing a natural velvet antler (20), wherein the natural velvet antler (20) comprises a hard antler (22) covered from any or all external sides by a soft tissue layer (24), and hairs (26) extending from the outside surface of the soft tissue layer (24);
creating a material mold (110) by applying a mold material onto the entire external surface of the natural velvet antler (20);
enabling the release of the hairs (26) from the soft tissue layer (24) and allowing hairs (26) to remain encased in the material mold (110);
removing the hard antler (22) and soft tissue (24) from the material mold (110) by cutting the material mold (110); wherein the material mold (110) comprises encased hair (26);
pouring a casting material (105) into a mold void (116), wherein the mold void (116) is formed inside the material mold (110) after the removal of the hard antler (22) and soft tissue (24) from the material mold (110);
allowing the casting material (105) to be cured inside the mold void (116), thereby forming a replica deer antler (100); and
removing the material mold (110) from the replica deer antler (100); wherein the newly formed velvet-transfer replica deer antler (100) includes hair (26) embedded in the casting material (105).

2. The method for the formation of a velvet-transfer replica deer antler (100) according to claim 1, wherein the material mold (110) is supported by using a rigid mother mold (120) that includes flanges (114) that are removably connected to each other.

3. The method for the formation of a velvet-transfer replica deer antler (100) according to claim 1, wherein the hairs (26) are released from the soft tissue layer (24) using natural bacterial decomposition.

4. The method for the formation of a velvet-transfer replica deer antler (100) according to claim 1, wherein the hairs (26) are released from the soft tissue layer (24) using a process selected from a group comprising of: chemical application, heating, and combinations thereof.

5. The method for the formation of a velvet-transfer replica deer antler (100) according to claim 1, wherein the casting material (105) comprises at least one of: plastic, acrylic (PMMA), acrylonitrile butadiene styrene (ABS), nylon (polyamide, PA), polycarbonate (PC), polyethylene (PE), polyoxymethylene (POM) and combinations thereof.

6. The method for the formation of a velvet-transfer replica deer antler (100) according to claim 1, wherein the natural velvet antler (20) is selected from an animal comprising of: mule deer, elk, reindeer, moose, red deer, Fallow deer caribou, Chital, sambar deer, or any other member of the deer family (Cervidae).

7. The method for the formation of a velvet-transfer replica deer antler (100) according to claim 1, wherein the mold material (110) comprises at least one of: silicone, wax, and combinations thereof.

8. The method for the formation of a velvet-transfer replica deer antler (100) according to claim 1, comprising the additional step of initially rehydrating the natural velvet antler (20) with water.
